(19) United States
(12) Patent Application Publication
(10) Pub. No.: US 2010/0318418 A1
(43) Pub. Date: Dec. 16, 2010

(54) ADVERTISING INVENTORY PREDICTION FOR FREQUENCY-CAPPED LINES

(75) Inventors: DAVID L. WERTHEIMER, SAN FRANCISCO, CA (US); MANAN SANGHI, BELLEVUE, WA (US); ROOPAK GUPTA, SANTA CLARA, CA (US); VIVEK S. VAIDYA, MOUNTAIN VIEW, CA (US); JAMES P. BEKEMEIER, SAN FRANCISCO, CA (US); MICHAEL J. GOLDBACH, ALBANY, CA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/485,633

(22) Filed: Jun. 16, 2009

(51) Int. Cl. G06Q 10/00; G06Q 30/00

(52) U.S. Cl. 705/14.45; 705/14.48; 705/14.61

(57) ABSTRACT

Computer-readable media, computer systems, and computing devices for responding to advertising inventory queries that specify frequency caps limiting the number of impressions that are shown to a unique user. Impression logs are retrieved from logging servers and processed to generate a unique user distribution that provides information regarding the numbers of unique users that receive ad impressions at a specified location and during a specified time period. Estimates of frequency-capped capacity to fulfill a booking request and estimates of frequency-capped availability of inventory are computed using the unique user distribution.

### BACKGROUND

Advertisers that advertise online strive to find an optimal set of consumers and to reach out to those consumers with an advertising campaign that is well-targeted and economical. To meet this need, advertising platforms often allow advertisers to query the system to determine availability of advertising inventory. Currently, the estimates provided in response to such requests ignore previous bookings and frequency caps that advertisers may wish to employ, the latter being a cap on the number of times a given unique user should be presented with an advertising impression during a specified period of time. As a result, the estimated inventory capacity and availability are often inaccurate and result in over-booking or under-booking in advertising campaigns.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the invention generally relate to computer-readable media and a computing device for managing advertising inventory by providing responses to inventory requests that take frequency caps into account. In embodiments, advertisers interact with an interface to configure advertising (“ad”) campaigns. In embodiments, ad campaigns can be configured according to parameters supplied by the advertisers. A set of parameters supplied by an advertiser can, according to some embodiments, comprise a frequency cap that indicates a desired limitation on the number of ad impressions that should be delivered to a unique user over a given period of time. When booking ad campaigns, advertisers submit an inventory query so that they can determine whether the location has the capacity and availability of inventory to accommodate the booking request.

According to embodiments of the invention, an ad network hosts a capacity analysis engine that is configured to retrieve impression logs from logging servers. Using the impression logs, the capacity analysis engine can generate a unique user distribution (UUD) and use that distribution to compute estimates for frequency-capped capacity and frequency-capped inventory availability. According to various embodiments, numerous levels of granularity can be employed in the computations. The results of the computations can be provided to the advertiser, publisher, and any other entity having an interest in the estimates.

### BRIEF DESCRIPTION OF THE DRAWINGS

Embodiments of the inventions are described in detail below with reference to the attached drawing figures, wherein:

FIG. 1 is a block diagram of an exemplary computing device suitable for implementing embodiments of the invention;

FIG. 2 is a block diagram of an exemplary networking environment suitable for use in implementing embodiments of the invention;

FIG. 3 is a schematic diagram illustrating an exemplary implementation of the present invention;

FIG. 4 is a flow diagram illustrating an exemplary method of managing an advertising inventory in accordance with embodiments of the invention; and

FIG. 5 is another flow diagram illustrating an exemplary method of managing an advertising inventory in accordance with embodiments of the invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the invention described herein include systems and methods for managing advertising inventory capacity. In a first illustrative embodiment, a set of computer-executable instructions provides an exemplary method of managing advertising inventory capacity associated with an advertising location for responding to an advertising booking request from an advertiser, wherein the advertiser specifies a predetermined frequency cap. Embodiments of the exemplary method include receiving an online advertising booking proposal that includes an inventory request for an identified advertising location. Advertising impression logs are received from one or more logging servers associated with the identified advertising location. Embodiments of the exemplary method further include processing the impression logs to generate a Unique User Distribution (UUD) for the identified advertising location during a specified time period. Using the UUD, a frequency-capped capacity can be predicted for the inventory request. A number of impressions available for the inventory request can also be determined. In embodiments, the predicted frequency-capped capacity and the number of impressions available can be displayed to an advertiser.

In a second illustrative embodiment, a set of computer-executable instructions provides an exemplary method of managing advertising inventory capacity associated with an identified orderable advertising location for responding to a booking request from an advertiser, wherein the advertiser specifies a predetermined frequency cap. Embodiments of the exemplary method include retrieving impression logs from one or more logging servers associated with the identified orderable advertising location. The impression logs are sorted into unique user buckets such that each unique user bucket contains one or more impression logs associated with the corresponding unique user. In embodiments, a plurality of partial unique user distributions are generated and combined to generate a UUD corresponding to the identified orderable advertising location. Upon receiving an inventory request specifying a frequency cap from an advertiser, embodiments of the exemplary method further include determining a predicted capacity associated with the location and determining a number of impressions available for the inventory request. A response to the advertiser is provided and includes the predicted capacity and number of impressions available.

In a third illustrative embodiment, a computing device is provided that analyzes advertising impression logs associated with a specified orderable advertising location to predict frequency capping aware inventory capacity and availability based on a UUD generated by the computing device. In embodiments, the computer system includes a storage medium having a number of program modules embodied thereon. When executed by a processor, the modules include a pre-processing module that retrieves impression logs associated with an identified orderable location from a logging server and generates a plurality of unique user buckets, wherein each unique user bucket includes impression logs associated with the user. Embodiments of the invention also include a partial-UUD (PUUD) generation module that generates a plurality of partial unique user distributions (PUUDs). According to various embodiments, the computing device includes a UUD module that combines the plurality of PUUDs to generate a UUD corresponding to the specified orderable advertising location. In embodiments, the computing system also includes a capacity analysis engine that predicts a capped capacity for the inventory request associated with the advertising location.

Various aspects of embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including dedicated servers, general-purpose computers, laptops, more specialty computing devices, and the like. The invention may also be practiced in distributed computing environments where tasks are performed by remote-processing devices that are linked through a communications network.

Computer-readable media include both volatile and nonvolatile media, removable and nonremovable media, and contemplate media readable by a database, a processor, a router, and various other networked devices. By way of example, and not limitation, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

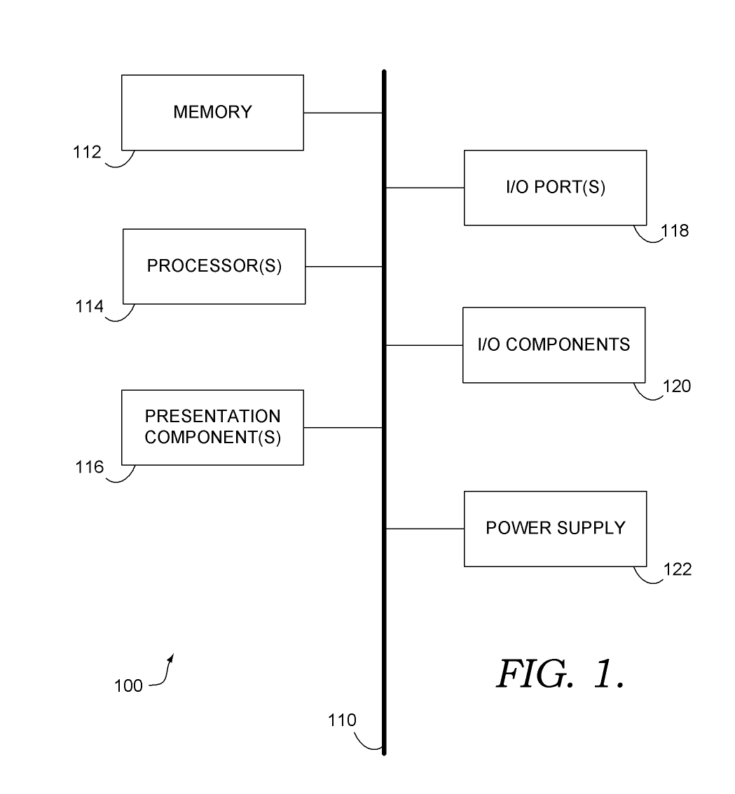

An exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors 114 coupled with system bus 110 that read data from various entities such as memory 112 or I/O components 120. The one or more processors 114 execute computer-readable instructions to perform various tasks and methods defined by the computer-readable instructions. Presentation component(s) 116 are coupled to system bus 110 and present data indications to a user or other device. Exemplary presentation components 116 include a display device, speaker, printing component, etc.

I/O ports 118 allow computing device 100 to be logically coupled to other devices including I/O components 120, some of which may be built in. Illustrative components include a microphone, joystick, game pad, satellite dish, scanner, printer, wireless device, keyboard, pen, voice input device, touch input device, touch-screen device, interactive display device, and a mouse.

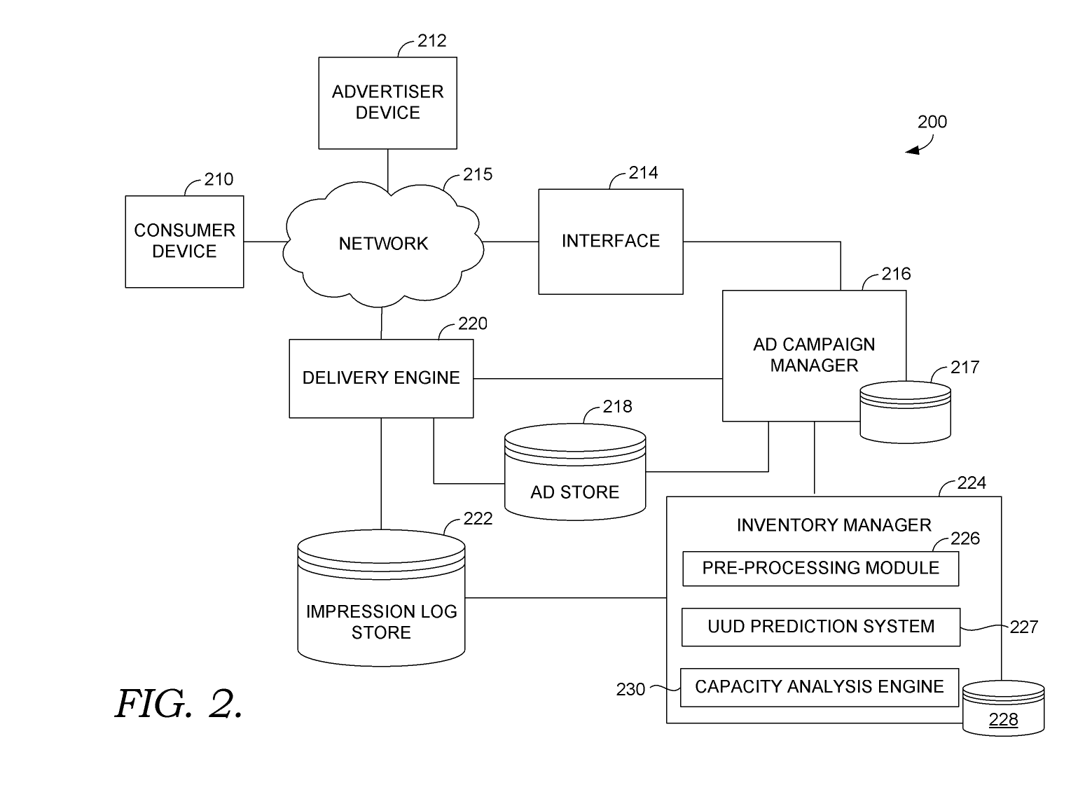

Turning now to FIG. 2, a block diagram of an exemplary network environment 200 suitable for use in implementing embodiments of the inventions is shown. Network environment 200 includes a consumer device 210, an advertiser device 212, a network 215, an interface 214, an ad campaign manager 216, an advertising (ad) store 218, a delivery engine 220, an impression log store 222, and an inventory manager 224. Network 214 can include any kind of suitable network such as, for example, a local area network (LAN), a wide area network (WAN), the Internet, a cellular network, a peer-to-peer (P2P) network, a mobile network, or a combination of networks. In an embodiment of the invention, network environment 200 includes components, servers, modules, or other technology that facilitates the delivery and/or presentation of advertisements to various destinations such as, for example, mobile devices, computing devices and content providers. The exemplary network environment 200 shown in FIG. 2 is an example of one suitable network environment 200 and is not intended to suggest any limitation as to the scope of use or functionality of embodiments of the inventions disclosed throughout this document. Neither should the exemplary network environment 200 be interpreted as having any dependency or requirement related to any single component or combination of components illustrated therein.

According to embodiments of the invention, interface 214, ad campaign manager 216, ad store 218, delivery engine 220, impression log store 222, and inventory manager 224 can be implemented on any number of types of computing devices. In one embodiment, for example, interface 214, ad campaign manager 216, ad store 218, delivery engine 220, impression log store 222, and inventory manager 224 can be implemented on a single computing device. In another embodiment, interface 214, ad campaign manager 216, ad store 218, delivery engine 220, impression log store 222, and inventory manager 224 are each implemented on separate computing devices. In other embodiments, interface 214, ad campaign manager 216, ad store 218, delivery engine 220, impression log store 222, and inventory manager 224 are implemented on a distributed processing system using several interconnected computing devices. In a further embodiment, combinations of the components 214, 216, 218, 220, 222, and 224 can be implemented on any number of machines and according to any number of various combinations.

Consumer device 210 can take the form of various types of computing devices such as, for example, computing device 100 described above with reference to FIG. 1. For example, the consumer device 210 may be a personal computing device (PC), a handheld device (e.g., personal digital assistant), a mobile device (e.g., laptop computer, cell phone, media player), a consumer electronic device, a server, and the like. Additionally, consumer device 210 may comprise two or more electronic devices configured to share information with each other.

In one embodiment, for example, consumer device 210 is a personal computer (PC) that a consumer has at home or at work. In a further embodiment, consumer device 210 can be a kiosk, a public network access terminal, a media management system such as may be available on a TV in a hotel room, or other device. According to embodiments of the invention, consumer device 210 can communicate with one or more of the other elements illustrated in FIG. 2. Similarly, advertiser device 212 can be any type of computing device capable of allowing an advertiser to communicate with ad campaign manager 216, via interface 214, to configure advertising campaigns and the like.

In embodiments, interface 214 can include an interface, an application programming interface (API), a method, a function call, a hardware device, and/or any other type of conduit configured for allowing information to be provided to various components illustrated in FIG. 2. In one embodiment, interface 214 provides a user interface that allows an advertiser to configure an ad campaign. In other embodiments, interface 214 can provide a communication conduit to ad campaign manager 216 through which an advertiser can submit configuration parameters associated with an advertising campaign, frequency caps, booking proposals, advertising inventory requests, and the like. The term “advertising inventory” refers to the total number of available impressions for a particular targeted market segment and/or advertising location. Various aspects of the invention utilize the concept of orderable locations. An orderable location refers to an aggregation of advertising placement identifiers, where each of the advertising placement identifiers represents a deliverable descendant of the corresponding orderable location.

Ad campaign manager 216 can include any number of types of computing devices capable of managing and maintaining data associated with a number of advertising campaigns. According to various embodiments of the invention, ad campaign manager 216 provides a user-interface that allows an advertiser to configure any number of different aspects of an advertising campaign. Additionally, ad campaign manager 216 receives advertising booking proposals, inventory requests, and the like from advertiser device 212. According to embodiments of the invention, ad campaign manager 216 communicates with inventory manager 224. In embodiments, inventory manager 224 receives advertising booking proposals, inventory requests, inventory queries, and the like from ad campaign manager 216. In some embodiments, inventory manager 224 receives these communications through interface 214.

As illustrated in FIG. 2, ad campaign manager 216 includes database 217. Database 217 provides information for managing ad campaigns for presentation of advertisements to consumers. In an embodiment, database 217 is a content server that has associated storage for storing information such as URLs, consumer profiles, configuration data, and the like. In an embodiment, database 217 can be a server, computing device, storage medium, or software module that can maintain information. In embodiments, database 217 might be computing devices associated with a company that produces advertisements. In another embodiment, database 217 can be integrated with servers that can maintain, and manage numbers of advertisements that are associated with and received from various originating entities. It should be appreciated that database 217 can be designed to operate within various business models, ad inventory bidding schemes, and the like.

In an embodiment, database 217 is a database or other data storage module. In one embodiment, database 217 can be associated with ad campaign manager 216, delivery engine 220, interface 214, or another component of exemplary network environment 200 not illustrated in FIG. 2. Database 217 can be maintained on a single device, or can be distributed across several devices such as, for instance, in an implementation in which database 217 is a database cluster. Database 217 can be structured according to a variety of techniques and can be configured to be searchable. For example, in one embodiment, database 217 includes a table. In another embodiment, database 217 is a relational database that includes advertiser identifiers that identify advertisers stored in database 217 as well as data associated with various attributes corresponding to the advertiser identifiers.

With continued reference to FIG. 2, network environment 200 includes delivery engine 220. Delivery engine 220 can be any type of server, software module, computing device or the like that is capable of communicating with other devices. Delivery engine 220 provides advertisements or links to advertisements to other devices such as consumer devices, content providers, and the like. In some embodiments, advertisements include hyperlinks or other types of references that allow a consumer to access web sites, information, databases, and the like. Delivery engine 220 can facilitate consumer interaction with those advertisements by resolving references, mapping hyperlinks to addresses, retrieving websites, searching content, and rendering content. In some embodiments, delivery engine 220 can also provide click-through services for reporting consumer interaction with content.

Delivery engine 220 can interface with an ad store 218. Ad store 218 can include, for example, an ad database, a cache for temporarily storing advertisements and other content before providing the advertisements and/or other content to consumers, and the like. Additionally, in some embodiments, delivery engine 220 is integrated with ad store 218. In an embodiment, delivery engine 220 generates a searchable index of the advertisements and related data stored in ad store 218.

According to some embodiments, ad store 218 provides advertisements for presentation to consumers. In an embodiment, ad store 218 is a content server that has associated storage for storing advertisements, and can also include links to advertisements, information about advertisements, metadata, device location data, advertiser profile information, and the like. In an embodiment, ad store 218 can be a server, computing device, or software module that can provide advertisements or links to advertisements. In embodiments, ad store 218 might be a computing device associated with a company that produces advertisements. In another embodiment, ad store 218 can be a server that can collect, maintain, and manage numbers of advertisements that are associated with and received from various originating entities. It should be appreciated that ad store 218 can be designed to operate within various business models, purchasing schemes, and the like.

Ad store 218 can be used to store advertisements and information associated with advertisements. Ad store 218 can include one or more advertisement databases. Ad store 218 can include indexes associated with advertisement databases, and can also include information associated with advertisements, mappings between hyperlinks and content, and other types of content. In some embodiments, ad store 218 can be used to store scripts, APIs, and the like. In one embodiment, ad store 218 includes ad content associated with ad campaigns. Ad content can include text, graphics, animation, video, audio, and the like.

In an embodiment, ad store 218 is a database or other data storage module. In one embodiment, ad store 218 can support an advertising database. In other embodiments, ad store 218 can be associated with delivery engine 220, interface 214, or another component of network environment 200 not illustrated in FIG. 2. Ad store 218 can be maintained on a single device, or can be distributed across several devices such as, for instance, in an implementation in which ad store 218 is a database cluster. Ad store 218 can be structured according to a variety of techniques and is configured to be searchable. For example, in one embodiment, ad store 218 includes a table. In another embodiment, ad store 218 is a relational database that includes advertisement identifiers that identify advertisements stored in ad store 218 as well as data associated with various attributes corresponding to the advertisement identifiers. Advertisement identifiers can include dynamically generated identification codes, hyperlinks, URLs, or other addressing or identifying information. In one embodiment, for example, an attribute or attributes can represent information that indicates a geographical region wherein the advertisement corresponding to the associated advertisement identifier should be presented. In another embodiment, an attribute or attributes can represent information that identifies a frequency cap indicating a maximum number of advertising impressions that can be delivered to a unique user during a specified period of time. The term “advertising impression” refers to the single display of a single instance of an advertisement to a single user.

Ad store 218 also may be configured to store information associated with various types of advertisements. In various embodiments, such information may include, without limitation, one or more unapparent advertisements, one or more image advertisements, one or more consumer feedback advertisements, advertiser and/or publisher identities, frequency caps, and the like. In some embodiments, ad store 218 is configured to be searchable for one or more advertisements to be selected for presentation.

With continued reference to FIG. 2, delivery engine 220 facilitates the presentation of advertisements (i.e., ad content) to consumer device 210. Advertisements can include, for example, advertising content, information about advertising content, hyperlinks to advertisements, references to advertisements, uniform resource locators (URLs), coupons, and the like. Additionally, according to embodiments of the invention, advertisements can include scripts, software modules, and APIs that can be invoked to render advertising impressions on a presentation device associated with consumer device 210. Advertisements can be of any number of different formats such as audio, video, textual, graphical, and the like. In some embodiments, advertisements can be interactive and in other embodiments, advertisements are accompanied by click-through functionality so that consumer interaction with the advertisements can be monitored and logged. In some embodiments, delivery engine 220 resolves references, maps connections through hyperlinks, retrieves advertising content, streams content to consumer device 210, monitors click-throughs, and the like.

In various embodiments, delivery engine 220 acts as an impression logging server in that it captures and stores data associated with delivery of advertising impressions to users. In embodiments, delivery engine 220 captures information comprising a time-stamped indication of delivery of an advertising impression to a unique user. In embodiments, unique users can be identified by a unique user identifier (UUID), which a logging server can use to associate with information corresponding to delivery of an advertising impression to the user. Delivery engine 220 can store impression information locally or, according to some embodiments, in impression log store 222. In some embodiments of the invention, delivery engine 220 provides impression log information to a separate logging server (not illustrated in FIG. 2).

With continued reference to FIG. 2, exemplary network environment 200 includes inventory manager 224. In embodiments, inventory manager 224 provides functionality that allows for management and control of advertising inventory. Inventory manager 224 can include any number of program modules that enable various types and levels of control over an advertising inventory. In some embodiments, inventory manager 224 keeps track of inventory and processes bookings, inventory requests, inventory queries, and the like. In embodiments, inventory manager 224 can include modules that analyze inventory and provide various types of interpretive data about inventory, bookings, and the like. Although it will be understood that inventory manager 224 can, in various embodiments, provide numerous types of functionality, many are not germane to the present discussion and so will not be enumerated herein.

As illustrated in FIG. 2, inventory manager 224 includes a pre-processing module 226, a UUD prediction system 227, and a capacity analysis engine 230. In various embodiments, pre-processing module 226 retrieves impression logs from a logging server or data store such as, for example, delivery engine 220 or impression log store 222. Impression logs can be captured and stored for any number of reasons and various program modules, servers, or other entities can access impression logs and analyze information contained therein. Because capturing and maintaining impression logs is well-known in the art, details associated with impression logs and the processes and methods of capturing and storing impression logs will not be discussed herein.

As individuals familiar with the art will recognize, impression logs generally contain a great deal of information, only a small portion of which is used in the novel aspects of the invention disclosed herein. Accordingly, retrieving and storing (if even temporarily) entire impression logs can be burdensome for the system disclosed herein. For this reason, pre-processing module 226 retrieves impression logs for the time period during which the computations described below will be performed. For example, in an embodiment, pre-processing module 226 retrieves impression logs from a logging server for one day at a time. However, even one day's worth of impression logs can occupy considerable disk space. Therefore, pre-processing module 226 applies one or more filters to the retrieved impression logs to filter out unnecessary information.

According to various embodiments of the invention, pre-processing module 226 can be configured to filter out or keep any number of types of information, depending upon the granularity of analysis that is desired. In an embodiment, pre-processing module 226 filters out all information except for unique user identifiers (UUIDs) and primary scripting code (PSC). PSC provides an indication of the deliverable location corresponding to a particular advertising impression. Additionally, according to embodiments of the invention, pre-processing module 226 groups the impression logs according to UUID, generating a number of user “buckets.” In an embodiment, each user bucket contains impression logs associated with one particular UUID—and therefore, generally, one unique user. In other embodiments, each user bucket contains impression logs associated with a set of UUIDs. The user buckets can be stored in a local data store 228, which is accessible to pre-processing module 226, UUD prediction system 227, and capacity analysis engine 230. This pre-processing can be used to minimize the amount of data storage required for maintaining data being used for the analyses described below.

In one embodiment, for example, a set of impression logs may occupy one terabyte of memory. By applying the pre-processing functions described above, the size of the data may be reduced such that the bucketized data may occupy only around 300 gigabytes. After computing the UUD, which may occupy approximately 50 megabytes, the filtered and bucketized impression logs can be discarded to make room for additional data. In various embodiments, the use of pre-processing module 226 allows for the invention to be practiced on a single computing device—that is, pre-processing module 226, UUD prediction system 227, storage 228, and capacity analysis engine 230 may all be located on one computing device.

According to embodiments of the invention, storage 228 houses a historical store of UUDs. That is, pre-processing module 226 analyzes each user bucket to generate partial UUDs (PUUDs) and then combines the PUUDs to create a UUD. The UUD is stored in storage 228. In embodiments, UUD prediction system 227 retrieves UUDs from storage 228 and generates predicted UUDs based on the UUDs. In an embodiment, UUD prediction system 227 incorporates information about the seasonality and age of the historical UUDs in its prediction. Capacity analysis engine 230 accesses or retrieves the predicted UUDs to perform frequency cap aware inventory capacity and availability predictions. These predictions can be provided to advertisers so that the advertisers can make more informed choices about how to manage their advertising campaigns based on frequency-capped capacity and availability of inventory. Additionally, in other embodiments, the predictions can be used by publishers to determine whether an inventory request or booking proposal from an advertiser can be accommodated. In further embodiments, any number of other entities can consume the output of capacity analysis engine 230.

Capacity analysis engine 230 receives information from an advertiser through ad campaign manager 216. This information can include any number of types of data. In embodiments, capacity analysis engine 230 receives inventory requests that specify total numbers of impressions desired, orderable advertising locations, frequency caps, and the like. Using the information obtained from an advertiser, capacity analysis engine 230 can use the UUD prediction to compute frequency-capped capacity predictions as well as estimates of availability of inventory that take into account previously booked orders. Illustrative computations and algorithms are described below. According to various embodiments of the invention, capacity analysis engine 230 can compute capacity and availability estimates for any desired granularity of product, location, time period, and the like.

As used herein, the frequency capped (FC) constraint is defined by the tuple <f,v> where f is the count of the number of impressions to which a unique user can be exposed over a time period of length v. However, due to limitation on the unique user data, capacity analysis engine 230 converts an FC constraint to a daily FC constraint and uses the daily FC constraint as the basis for all of its computations. Given a FC constraint <f,v>, the daily FC constraint is the tuple <f,v′> where v′ is equal to a day and f′=f*(v′/v). It should be understood that for an FC constraint <f,v>, the daily FC constraint is a stricter constraint where v is larger than a day, and a looser constraint where v is less than a day. Since most scenarios of interest require FC constraints where v is greater than a day, the exemplary availability computations described herein will tend to be conservative.

As mentioned above, capacity analysis engine 230 generates a UUD by analyzing the filtered and bucketized impression logs. For example, in one embodiment, the UUD for an orderable location ω and time duration (tₛ, tₑ) is a sequence of numbers {a₁, . . . ,aₙ} where:
a) For i<n: aᵢ is the number of unique users who visited a deliverable descendent of ω exactly i times during the time interval (tₛ, tₑ); and
b) For i=n: aᵢ is the number of unique users who visited a deliverable descendent of ω at least i times during the time interval (tₛ, tₑ).

Thus, for a daily UUD, tₛ will be 0000 hours and tₑ will be 2400 hours in UTC for the same day. Moreover, capacity analysis engine 230 can compute a cumulative UUD. For a UUD S={a₁, . . . ,aₙ} with total number of impressions being A, let T be a sequence of cumulative impressions {b₁, . . . ,bₙ} where

$$\begin{matrix}For i < n \text{:} {b}_{i} = {\sum }_{j \leq i} i * {a}_{i} ; and & a ) \\ {b}_{n} = A . & b )\end{matrix}$$

To compute the UUD defined above, the data processing layer of capacity analysis engine 230 must be cognizant of all orderable locations and, for all of the orderable locations, all of the terminal locations (deliverable descendants of the orderable location) whose impressions get rolled up to the orderable location. In embodiments, UUDs can be generated at deliverable locations and internal locations. In some embodiments, UUDs can be generated for any inventory segment (e.g., males aged 18-24 that visit the autos section of a particular web site) over which capacity and avails predictions are requested. An exemplary algorithm for generating the UUD appears below. It should be appreciated that this algorithm assumes that all of the advertising placements are organized as a Directed Acyclic Graph (DAG), where the terminal nodes of the DAG represent the atomic advertising units (i.e., delivery locations) where the advertising platform receives the advertising requests and the internal nodes represent a grouping of all of the atomic advertising units corresponding to the terminal location that can be reached from the internal node.

The following is an exemplary algorithm for generating a UUD for each day (d) of the week:

```
1) Let A be an empty set
2) For each impression log on day d,
        a. For each entry <u,p> in the log where u is the user ID and p
is the primary scripting code (PSC)
                i. If u does not exists in A, then
                        1. Create a new record for u
                        2. Let the set of visited_locations(u)
                        be {<p,1>}
                        3. For each ancestor x of p, add <x,1> to
                visited_locations(u)
                ii. If u exists in A, then
                        1. If there exists <p,j> in
                visited_locations(u) replace <p,j> with <p,j+1>
else add <p,1> to visited_locations(u)
                        2. For each ancestor x of p: If there exists
                <x,j> in visited_locations(u) replace <x,j> with
        <x,j+1> else add <x,1> to
visited_locations(u)
3) For each location q,
        a. Initialize a1, a2, ..., an to 0
        b. Initialize w to 0
        c. For each user u in A, if <q,j> is in visited_locations(u) then
                i. If j<90, then increment aj by 1
                ii. If j>=90, increment a90 by 1
                iii. Increment w by j
        d. Output a1, a2, ...,an, w
```

It will be appreciated by those familiar with the art that capacity and availability predictions computed using the UUD as defined above will often embody inaccuracies due to any number of factors. For example, one source of inaccuracies can be User ID churn. That is, capacity analysis engine 230 may count the same user twice if the user deletes the user's ID cookie and is thus issued a new one. However, since users generally clear all their cookies together, this will often involve clearing of the frequency blob cookie as well; therefore, generally the inaccuracy will be shared by delivery engine 220. Another exemplary source of inaccuracies can be targeting. The processes described above essentially assume that all targeted segments have the same UUD as the untargeted segments. Inaccuracies may also arise due to differences in the timezone. For example, in one embodiment, the UUD are collected in the UTC while the frequency caps enforced by delivery engine 220 will be in the local time zone. Additionally, inaccuracies are inherent in the fact that the UUD is calculated based on historical data, but used to predict future data.

To mitigate the effect of these and other inaccuracies on the output of capacity analysis engine 230, UUDs can be generated at various granularities and over various inventory segments, allowing selection of granularities and/or inventory segments that yield more accurate predictions. In some embodiments, inaccuracies can be mitigated in any number of ways. For example, in an embodiment, several adjustment functions can be employed by capacity analysis engine 230. According to an embodiment of the invention, three configurable parameters are introduced that allow capacity analysis engine 230 to tune how conservative or aggressive its estimates for capacity and availability are. In other embodiments, other configurable parameters can be used. In some embodiments, capacity analysis engine 230 employs only one configurable parameter, while in other embodiments, more than three parameters might be used. According to one embodiment of the invention, the capacity analysis engine 230 introduces the following three configurable parameters:
1) α: used to tune how aggressive or conservative the availability computations will be;
2) β: used to tune the adjustment of estimates due to varying time periods; and
3) γ: used for overall adjustment to all numbers.

Functions can be defined for any and/or all of these parameters. For example, in an embodiment, capacity analysis engine 230 defines a function f(β,ν), which it uses to account for the inaccuracies due to using a day level UUD for frequency cap values of different time intervals. In embodiments, f(β,ν) is defined to satisfy the following conditions:
1) f(β,1)=1 for all β; and
2) f(β,ν) is monotonically increasing in β and ν.

In embodiments of the invention, capacity analysis engine 230 also defines a function g(γ), which it uses to account for overall inaccuracy in the estimates. In embodiments, g(γ) is defined to satisfy the following conditions:

1) g(γ) is monotonically increasing in γ; and

2) 0<g(γ) for all γ.

Capacity analysis engine 230 uses the UUD and adjustment functions and parameters to compute capacity predictions. The capacity for an inventory request on location ω for a time interval (t1,t2) with a daily FC constraint of <f,day> is computed as follows. Let the original FC constraint for the request by <f′,v> where v is expressed in number of days.
1) Decompose the time interval (t1,t2) into a sequence of time intervals S=(t1,s1),(s1,s2), . . . (sk,tk) where for all j, sj is midnight in UTC and the interval (sj,sj+1) spans 24 hours.
2) For each hour h in S, let the uncapped capacity be uh.
3) For each hour h in S, let the corresponding day of the week be dh.
4) Let {a₁, . . . ,aₙ} be the UUD for location ω on dh and let A be the total number of impressions corresponding to the UUD.
5) For each hour h in S, the computed Frequency Capped capacity c^{h} is given by the following formula:

$${c}^{h} = ( {\sum }_{i < f} i * {a}_{i} + {\sum }_{i \geq f} f * {a}_{i} ) * \frac{{u}^{h}}{A} * f ( β , v ) * g ( γ ) .$$

6) Because the uncapped capacity will necessarily be larger than the capped capacity, the frequency capped capacity prediction, C(h) is the minimum of the computed FC capacity and the uncapped capacity:

C(h)=min{c^{h},u^{h}}.

To illustrate the algorithm for computing FC capacity described above, consider a location Z with 10,000 uncapped impressions. One goal could be to determine the capacity of the location Z with a frequency cap of 14 per week. Now, suppose we have the following daily UUD for Z:

Total number of impressions: 15,000

Number if Unique Users who visited Z exactly once: 2000

Number if Unique Users who visited Z exactly 2 times: 1000

Number if Unique Users who visited Z exactly 3 times: 600

Number if Unique Users who visited Z exactly 4 times: 300

Number if Unique Users who visited Z exactly 5 or more times: 100

Because the UUD is defined for a day, it may be necessary to convert the given FC into a daily FC. FC may be specified in terms of any time unit, whether it be more or less granular than one day. For example, FC may be given in terms of seconds, minutes, hours, days, weeks, months, years, and the like. In the example above, the FC is specified in terms of a week, and accordingly, in an embodiment, the weekly FC is simply divided by the number of days in a week (i.e., 7). Thus, in this example, the weekly FC of 14 per week is converted to a daily FC of 2 per day. Accordingly, the problem becomes determining the capacity of the location Z with a FC of 2 per day. Of the 2000 users who visited the location Z once, they can be served with an advertising impression with a 2/day FC exactly once, for a total of 2000 impressions for this ad. Of the 1000 users who visited the location 2 times, they can be served with an advertising impression with a 2/day FC exactly 2 times, for a total of 1000*2 impressions for this ad. Of the 600 users who visited the location 3 times, they can be served with an advertising impression with a 2/day FC exactly 2 times, for a total of 600*2 impressions for this ad. Of the 300 users who visited the location 4 times, they can be served with an advertising impression with a 2/day FC exactly 2 times, for a total of 300*2 impressions for this ad. Of the 100 users who visited the location 5 or more times, they can be served with an advertising impression with a 2/day FC exactly 2 times, for a total of 100*2 impressions for this ad.

Therefore, the total capacity for an ad with a 2/day FC on the day the UUD was captured will be 2000*1+1000*2+600*2+300*2+100*2=6000 impressions. However, since our projection for uncapped capacity is 10,000 and the day this distribution was collected we had 15,000 total impressions, it can be helpful to scale the estimate of frequency capped impressions accordingly to output: 6,000*(10,000/15,000)=4000 impressions.

Capacity analysis engine 230 also computes an estimate of FC-aware availability. In an embodiment, the estimate of availability can be computed as a single number. In other embodiments, optimistic and pessimistic estimates (e.g., upper and lower bounds), or avails, can be calculated by choosing a value α where α is between the pessimistic and optimistic avails. For example, a pessimistic estimate (l′) and an optimistic estimate (m′) for availability can be computed to output a value (α*l′+(1−α)·m′) for some 0≦α≦1.

The lower bound (l′) on availability for an inventory request on location ω for a time interval (t₁,t₂) with a daily FC constraint of <f,day> is computed using the following algorithm:
(1) Decompose the time interval (t₁,t₂) into a sequence of time intervals S=(t₁,s₁),(s₁,s₂), . . .(sₖ,tₖ) where for all j, sⱼ is midnight in UTC and the interval (sⱼ,sⱼ₊₁) spans 24 hours.
(2) For each hour h in S, let the uncapped capacity be u^{x}.
(3) For each hour h in S, let the total allocated impressions be s^{x}.
(4) For each hour h in S, let the corresponding day of the week be d^{x}.
(5) Let {a₁, . . . ,aₙ} be the UUD for location ω on d^{x} and let A be the total number of impressions corresponding to the UUD. Let {b₁, . . . ,bₙ} be the corresponding sequence of cumulative impressions.
(6) For each hour h in S, the computed Frequency Capped lower bound on availability a^{x} is given by the following formula:

$${l}^{h} = ( {\sum }_{i < f , {b}_{i} > {s}^{k} \frac{A}{{u}^{k}}} i * {a}_{i} + {\sum }_{i \geq f , {b}_{i} > {s}^{k} \frac{A}{{u}^{k}}} f * {a}_{i} ) * \frac{{u}^{h}}{A} * f ( β , v ) * g ( γ ) .$$

(7) For each hour in S, the resulting FC lower bound on availability a^{x} is:

L^{h}=min{l^{h}, u^{h}}.

The upper bound (m′) on availability for an inventory request on location ω for a time interval (t₁,t₂) with a daily FC constraint of <f,day> is computed as follows:
1) Decompose the time interval (t₁,t₂) into a sequence of time intervals S=(t₁,s₁),(s₁,s₂), . . . (sₖ,tₖ) where for all j, sⱼ is midnight in UTC and the interval (sⱼ,sⱼ₊₁) spans 24 hours.
2) For each hour h in S, let the uncapped capacity be u^{k}.
3) For each hour h in S, let the total allocated impressions be s^{h}.
4) For each hour h in S, let the corresponding day of the week be d^{h}.
5) Let {a₁, . . . ,aₙ} be the UUD for location ω on d^{h} and let A be the total number of impressions corresponding to the UUD. Let {b₁, . . . ,bₙ} be the corresponding sequence of cumulative impressions.
6) For each hour h in S, the computed Frequency Capped upper bound on availability m′ is given by the following formula:

$${m}^{h} = ( {\sum }_{i < f , A - {b}_{i} > {s}^{k} \frac{A}{{u}^{k}}} i * {a}_{i} + {\sum }_{i \geq f , A - {b}_{i} > {s}^{k} \frac{A}{{u}^{k}}} f * {a}_{i} ) * \frac{{u}^{h}}{A} * f ( β , v ) * g ( γ ) .$$

7) Thus, the resulting upper bound is:

M^{h}=min.{m^{h}, u^{h}}.

In embodiments, capacity analysis engine 230 may be invoked to compute estimates of FC capacity and avails on locations for which there are insufficient impression logs to perform the calculations. In an embodiment, capacity analysis engine 230 can apply a default UUD to the scenario. According to various embodiments, a UUD representative of all locations can be generated and maintained in storage for use as a default UUD. In other embodiments, a default UUD can be manually input into capacity analysis engine 230, and in further embodiments, capacity analysis engine can use data from similar locations to generate a default UUD.

Upon being invoked as a result of an advertiser providing a booking request, inventory request, inventory query, or the like to ad campaign manager 216, capacity analysis engine 230 retrieves the necessary inputs an computes estimates for FC capacity and FC availability of inventory. The resulting estimates are provided to the advertiser, publisher, or other entity. For example, in an embodiment, capacity analysis engine 230 provides the computed estimates to ad campaign manager 216. Ad campaign manager causes the results to be displayed on a display device connected to advertiser device 212. In another embodiment, there may be an interface that allows advertiser device 212 to communicate directly with inventory manager 224, and thus, capacity analysis engine 230. The resulting capacity and availability estimates can be provided in any number of formats such as, for example, plain text, tables, charts, graphs, and the like. According to some embodiments, in addition to providing the capacity and availability estimates, inventory manager 224 can provide data that illustrates comparisons between the estimates and the inventory requested by the advertiser. Various types of visual presentation formats can be used to provide context for the advertiser. Additionally, in some embodiments, other program modules, routines, or the like can retrieve the capacity and availability estimates for use in other calculations.

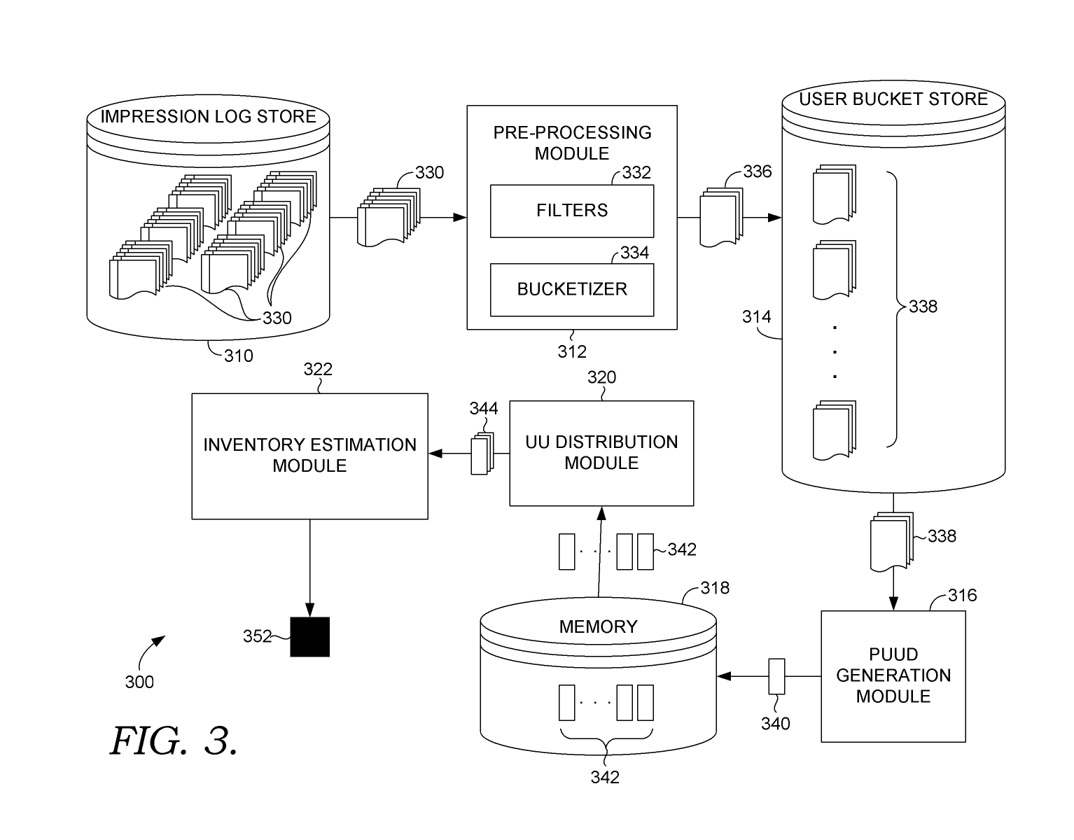

Turning now to FIG. 3, an exemplary implementation 300 of an embodiment of the invention is depicted using a schematic diagram. As illustrated, the exemplary implementation 300 includes an impression log store 310, a pre-processing module 312, a user bucket store 314, a PUUD generation module 316, memory 318, a UU distribution module 320, and an inventory estimation module 322. The exemplary implementation 300 shown in FIG. 3 is an example of one suitable implementation 300 and is not intended to suggest any limitation as to the scope of use or functionality of embodiments of the inventions disclosed throughout this document. Neither should the exemplary implementation 300 be interpreted as having any dependency or requirement related to any single component or combination of components illustrated therein.

As discussed above, impression log store 310 can include a database, server, delivery engine, and the like. Impression log store 310 maintains impression logs 330 associated with an advertising location. In an embodiment, pre-processing module 312 retrieves impression logs 330 from impression log store 310. Pre-processing module 312 includes filters 332 that remove extraneous information from impression logs 330. Pre-processing module 312 also includes a bucketizer 334, which consists of a program module that groups impression logs by unique user identifier (UUID) such as, for example, by performing a one-way hash on UUID. The bucketizer 334 stores the pre-processed impression logs 336 in user bucket store 314 by placing each group of impression logs into a “bucket” 338 that is associated with the UUID.

With continued reference to FIG. 3, PUUD generation module 316 retrieves each bucket 338 and computes a partial unique user distribution (PUUD) based on the data in the corresponding bucket 338. The PUUD generation module 316 can store PUUDs in memory 318 until UU distribution module 320 requests it. As shown in FIG. 3, UU distribution module 334 retrieves a number of buckets 342 associated with a particular location. UU distribution module 320 generates a UUD 344 using the input data and provides the UUD 344 to inventory estimation module 322. Inventory estimation module 322 uses the UUD 344 to compute estimates for FC capacity and availability. These estimates can be provided as output 352 to an advertiser, publisher, network administrator, or the like.

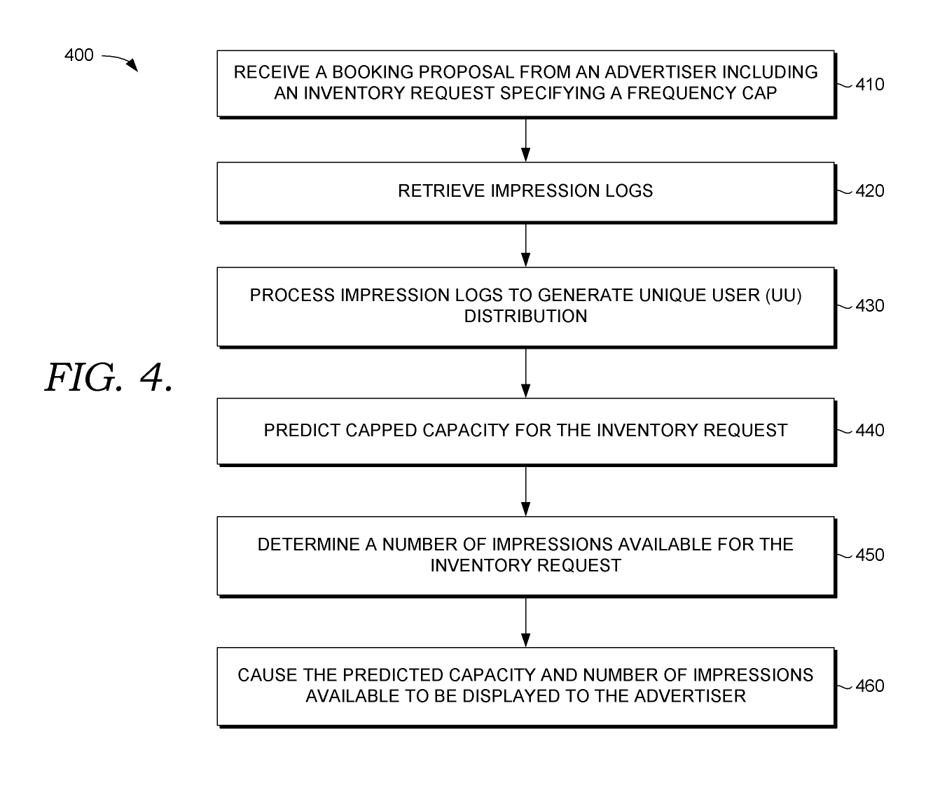

With reference now to FIG. 4, a flow diagram is illustrated that shows an exemplary method for managing advertising inventory capacity associated with an advertising location for responding to an advertising booking request from an advertiser, wherein the advertiser specifies a predetermined frequency cap in accordance with embodiments of the invention. Initially, as depicted at block 410, embodiments of the exemplary computer-implemented method include receiving an online advertising booking proposal from an advertiser. The booking proposal can include an inventory request for advertising impressions to be delivered to targeted users on an identified orderable advertising location for a first time interval. According to embodiments, targeted users include users that satisfy one or more advertising targeting criteria defined by the advertiser. In various embodiments, the identified orderable advertising location includes a set of placement identifiers that correspond to deliverable descendents of the identified orderable advertising location. The inventory request further specifies a frequency cap associated with the identified orderable advertising location.

At step 420, a plurality of impression logs are retrieved from one or more logging servers associated with the identified orderable advertising location. The impression logs include information associated with a number of advertising impressions that were displayed to a unique users. In embodiments, each impression log includes a time-stamped indication that an advertising impression was presented to a unique user on the deliverable advertising location. As illustrated at step 430, embodiments of the exemplary method include processing the plurality of impression logs to generate a Unique User Distribution (UUD) for the identified orderable advertising location.

As illustrated at step 430, the impression logs are processed to generate a Unique User Distribution (UUD) for the identified orderable advertising location. According to various embodiments of the invention, the UUD comprises a sequence of numbers, {a1, a2, . . . , aN}, each number representing a number of unique users that visited a deliverable descendant of the identified orderable advertising location during a specified period. In an embodiment, aN is the number of unique users who visited a deliverable descendent of the identified orderable advertising location at least N times during the specified time period and the sequence of numbers, {a1, a2, . . . , aN} is defined such that for i<N, ai is the number of unique users who visited a deliverable descendent of the identified orderable advertising location exactly i times during the specified time period.

In some embodiments, processing the impression logs also includes sorting the plurality of impression logs into a plurality of unique user groupings, generating a plurality of partial unique user distributions (PUUDs), where each partial unique user distribution (PUUD) includes a distribution that describes the number of impressions delivered to a specified unique user, and combining the plurality of PUUDs to generate the UUD. At step 440, embodiments of the exemplary method include predicting a capped capacity for the inventory request associated with the identified orderable advertising location.

At step 450, the method includes determining a number of impressions available for the inventory request while taking into account the frequency cap. In embodiments, determining the number of impressions available includes incorporating an impact on available inventory caused by previously booked advertising orders. According to some embodiments, determining the number of impressions available for the booking request includes computing a pessimistic estimate of avails and an optimistic estimate of avails, where the pessimistic estimate of avails comprises a lower bound on availability for the inventory request and the optimistic estimate of avails comprises an upper bound on availability for the inventory request.

At a final illustrative step, step 460, the predicted capped capacity and number of impressions available are caused to be displayed to the advertiser. In embodiments, an ad campaign manager can provide a user-interface that includes the information. In some embodiments, one or more configurable adjustment functions are applied to at least one of the predicted capped capacity and the number of impressions available. In embodiments, each adjustment function includes a configurable parameter that is used to tune an adjustment to account for an inaccuracy in calculations.

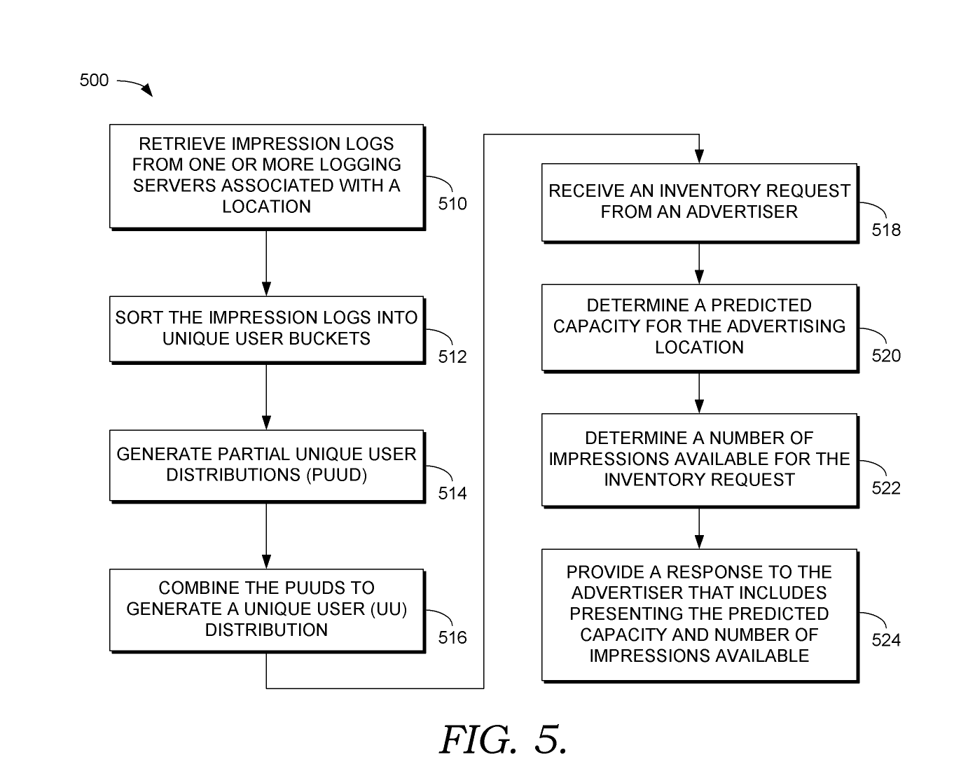

Turning to FIG. 5, a flow diagram is illustrated that shows an exemplary method for managing advertising inventory capacity associated with an identified orderable advertising location for responding to a booking request from an advertiser, wherein the advertiser specifies a predetermined frequency cap. At a first illustrative block 510, an embodiment of the exemplary method includes retrieving a plurality of impression logs from one or more logging servers associated with the identified orderable advertising location. The plurality of impression logs include information associated with a number of advertising impressions that were displayed to a number of unique users during a first period of time, and each impression log includes a time-stamped indication that an advertising impression was presented to a unique user (e.g., identified by a unique user identifier (UUID)) on the orderable advertising location.

At step 512, the impression logs are sorted into a number of unique user buckets, each unique user bucket corresponding to a UUID. In embodiments, each unique user bucket includes impression logs associated with the UUID. At step 514, a partial unique user distribution (PUUD) is generated for each user bucket. In some embodiments, information in user buckets can be weighted to increase accuracy. For example, in one embodiment, recent information can be weighted heavier than other information.

At step 516, the PUUDs are combined to generate a unique user distribution (UUD) corresponding to the advertising location during a second period of time. As shown at step 518, an inventory request for a specific location and frequency cap is received from an advertiser. Step 520 includes determining a predicted capacity associated with the advertising location, where the predicted capacity is constrained by the frequency cap. At step 522, a number of impressions available for the inventory request is determined and, as shown at step 524, a response is provided to the advertiser. The response includes the predicted capacity and number of impressions available, which are caused to be displayed to the advertiser.

Various embodiments of the invention have been described to be illustrative rather than restrictive. Alternative embodiments will become apparent from time to time without departing from the scope of embodiments of the inventions. It will be understood that certain features and sub-combinations are of utility and may be employed without reference to other features and sub-combinations. This is contemplated by and is within the scope of the claims.

The invention claimed is:

1. One or more computer-readable media having computer-executable instructions embodied thereon for performing a method of managing advertising inventory capacity associated with an advertising location for responding to an advertising booking request from an advertiser, wherein the advertiser specifies a predetermined frequency cap, the method comprising:
receiving an online advertising booking proposal from an advertiser, the booking proposal comprising an inventory request for advertising impressions to be delivered to targeted users on an identified orderable advertising location for a first time interval, the first time interval being defined by the advertiser, wherein the inventory request further specifies a frequency cap associated with the identified orderable advertising location, the frequency cap comprising a limitation on a total number of impressions that can be delivered to each unique user over a -second time period;
retrieving a plurality of impression logs from one or more logging servers associated with the identified orderable advertising location, the plurality of impression logs comprising information associated with a plurality of advertising impressions that were displayed to a plurality of unique users during a third period of time, wherein each impression log comprises a time-stamped indication that an advertising impression was presented to a unique user on the orderable advertising location, the unique user being associated with a unique user identifier (UUID);
processing the plurality of impression logs to generate a Unique User Distribution (UUD) for the identified orderable advertising location during the third time period, wherein the UUD can be used to predict frequency capping (FC) aware inventory predictions associated with the identified advertising location;
predicting a capped capacity for the inventory request associated with the identified orderable advertising location, wherein said predicted capped capacity comprises an inventory capacity prediction that is constrained by the frequency cap;
determining a number of impressions available for the inventory request, wherein the number of impressions available is constrained by the frequency cap, wherein said determining comprises incorporating an impact on available inventory caused by previously booked advertising orders; and
causing the predicted capped capacity and number of impressions available to be displayed to the advertiser.

2. The one or more computer-readable media of claim 1, wherein targeted users comprise users that satisfy one or more advertising targeting criteria defined by the advertiser.

3. The one or more computer-readable media of claim 1, wherein the identified orderable advertising location comprises a set of placement identifiers, each placement identifier corresponding to a deliverable descendent of the identified orderable advertising location.

4. The one or more computer-readable media of claim 3, wherein the UUD comprises a sequence of numbers, {a1, a2, . . . , aN}, each number representing a number of unique users that visited a deliverable descendant of the identified orderable advertising location during the third time period.

5. The one or more computer-readable media of claim 4, wherein aN is the number of unique users who visited a deliverable descendent of the identified orderable advertising location at least N times during the third time period.

6. The one or more computer-readable media of claim 5, wherein the sequence of numbers, {a1, a2, . . . , aN} is defined such that for i<N, ai is the number of unique users who visited a deliverable descendent of the identified orderable advertising location exactly i times during the third time period.

7. The one or more computer-readable media of claim 1, wherein processing the plurality of impression logs further comprises:
sorting the plurality of impression logs into a plurality of unique user groupings, each unique user grouping corresponding to a UUID, wherein each unique user grouping comprises one or more impression logs associated with the UUID;
generating a plurality of partial unique user distributions, each partial unique user distribution (PUUD) comprising a distribution that describes the number of impressions delivered to a specified unique user, wherein each PUUD corresponds to one of the plurality of user buckets; and
combining the plurality of PUUDs to generate the UUD.

8. The one or more computer-readable media of claim 1, wherein determining the number of impressions available for the booking request comprises computing a pessimistic estimate of avails and an optimistic estimate of avails, wherein the pessimistic estimate of avails comprises a lower bound on availability for the inventory request, and further wherein the optimistic estimate of avails comprises an upper bound on availability for the inventory request.

9. The one or more computer-readable media of claim 1, further comprising applying one or more configurable adjustment functions to at least one of the predicted capped capacity and the number of impressions available, wherein each adjustment function comprises a configurable parameter that is used to tune an adjustment to account for an inaccuracy in calculations, wherein the inaccuracy results from one or more simplifying assumptions made during calculation.

10. One or more computer-readable media having computer-executable instructions embodied thereon for performing a method of managing advertising inventory capacity associated with an identified orderable advertising location for responding to a booking request from an advertiser, wherein the advertiser specifies a predetermined frequency cap, the method comprising:
retrieving a plurality of impression logs from one or more logging servers associated with the identified orderable advertising location, the plurality of impression logs comprising information associated with a plurality of advertising impressions that were displayed to a plurality of unique users during a first period of time, wherein each impression log comprises a time-stamped indication that an advertising impression was presented to a unique user on the orderable advertising location, the unique user being associated with a unique user identifier (UUID);
sorting the plurality of impression logs into a plurality of unique user buckets, each unique user bucket corresponding to a UUID, wherein each unique user bucket comprises one or more impression logs associated with the UUID;
generating a plurality of partial unique user distributions, each partial unique user distribution (PUUD) comprising a distribution that describes the number of impressions delivered to a specified unique user over a second period of time, wherein each PUUD corresponds to one of the plurality of user buckets;
combining the plurality of PUUDs to generate a unique user distribution (UUD) corresponding to the advertising location during a second period of time;
receiving an inventory request from an advertiser, wherein the inventory request comprises a predetermined frequency cap;
determining a predicted capacity associated with the advertising location, wherein the predicted capacity is constrained by the frequency cap;
determining a number of impressions available for the inventory request; and
providing a response to the advertiser, wherein providing the response comprises causing the predicted capacity and number of impressions available to be displayed to the advertiser.

11. The one or more computer-readable media of claim 10, wherein determining a predicted capacity associated with the advertising location comprises computing a predicted capacity for aggregated products.

12. The one or more computer-readable media of claim 11, further comprising predicting at least one of an optimistic estimate for total frequency aware availability and a pessimistic estimate for total frequency aware availability.

13. The one or more computer-readable media of claim 10, wherein generating a plurality of partial unique user distributions further comprises weighting information contained in impression logs based on how recently the impressions were logged.

14. The one or more computer-readable media of claim 10, wherein determining the predicted capacity comprises determining a predicted capacity for a third time period, wherein the third time period is larger than the second time period.

15. The one or more computer-readable media of claim 10, wherein determining the predicted capacity comprises determining a predicted capacity for a third time period, wherein the third time period is smaller than the second time period.

16. A computing device that analyzes advertising impression logs associated with a specified orderable advertising location to predict frequency capping aware inventory capacity and availability based on a unique user distribution (UUD) generated by the computing device, the computing device comprising:
a system bus that couples a plurality of system components, the plurality of system components comprising:
a display device;
a first input port that facilitates receiving advertising impression logs from a logging server, wherein the logging server communicates with the computing device over a network via the input port;
a second input port that facilitates receiving an online advertising booking proposal from an advertiser, the booking proposal comprising an inventory request for advertising impressions to be delivered to targeted users on an identified orderable advertising location for a first time interval, the first time interval being defined by the advertiser, wherein the inventory request further specifies a frequency cap associated with the identified orderable advertising location, the frequency cap comprising a limitation on a total number of impressions that can be delivered to each unique user over a second time period;
a mass storage device that reads from and writes to nonremovable computer-storage media, the mass storage device being connected to the system bus through a memory interface, wherein the computer-storage media stores computer-readable instructions, the computer-readable instructions defining one or more methods for processing advertising impression logs;
a processing unit that executes the computer-readable instructions to provide a plurality of program modules that process advertising impressions to predict frequency capping aware inventory capacity and availability based on a unique user distribution (UUD), the plurality of program modules comprising:
a pre-processing module that communicates with a logging server through a network, wherein the pre-processing module retrieves a plurality of advertising impression logs from the logging server and generates a plurality of unique user buckets, each unique user bucket corresponding to a unique user identifier (UUID), wherein each unique user bucket comprises one or more impression logs associated with the UUID;
a partial-UU distribution generation module that generates a plurality of partial unique user distributions, each partial unique user distribution (PUUD) comprising a distribution that describes the number of impressions delivered to a specified unique user, wherein each PUUD corresponds to one of the plurality of user buckets;
a UUD module that combines the plurality of PUUDs to generate a unique user distribution (UUD) corresponding to the specified orderable advertising location; and
a capacity analysis engine that predicts a capped capacity for the inventory request associated with the identified orderable advertising location, wherein said predicted capped capacity comprises an inventory capacity prediction that is constrained by the frequency cap.

17. The computing device of claim 16, wherein the pre-processing module comprises:
one or more filters that remove information from the impression logs, wherein the removed information is not useful for generating a UUD; and
a bucketizer that creates a bucket for each unique user, the bucket comprising impression logs associated with the unique user.

18. The computing device of claim 16, wherein the capacity analysis engine comprises:
a capacity prediction module that determines a predicted total capacity associated with the identified orderable advertising location;
an availability prediction module that determines a predicted total availability associated with the identified orderable advertising location; and
an adjustment module that facilitates adjusting the predicted total capacity to account for errors in estimations.

19. The computing device of claim 18, wherein the capacity analysis engine comprises a weighting module for weighting information contained in impression logs based on how recently the impressions were logged.

20. The computing device of claim 16, wherein the logging server comprises a delivery engine that facilitates providing advertising impressions to users.
